(19) United States
(12) Patent Application Publication
(10) Pub. No.: US 2026/0064249 A1
(43) Pub. Date: Mar. 5, 2026

(54) Crossmodal Interface Automation And Orchestration Without Api Integration

(71) Applicant: Ramin Bolouri, Concord, CA (US)

(72) Inventor: Ramin Bolouri, Concord, CA (US)

(21) Appl. No.: 19/313,686

(22) Filed: Aug. 28, 2025

Related U.S. Application Data
(60) Provisional application No. 63/688,244, filed on Aug. 28, 2024.

(51) Int. Cl. G06F 3/0484; G06F 18/214; G06F 40/284; G10L 15/18

(52) U.S. Cl. CPC G06F 3/0484; G06F 18/214; G06F 40/284; G10L 15/1815

(57) ABSTRACT

A system automates tasks in software applications without invoking a published API of the target application at runtime. Synchronized visual display frames, input events, audio of a task request, and text from digital procedures are captured and aligned to form crossmodal tokens. A Large Action Model maps tokens to user-interface actions, and a Large Orchestration Model composes and orders the actions to satisfy a goal and policy constraints. An executor issues operating-system native input signals to the target application and verifies outcomes from subsequent display frames using optical character recognition and layout cues. A feedback loop updates the models. The approach provides no-integration automation across legacy and modern applications with semantic reanchoring for UI changes and privacy protections.

### CROSS-REFERENCE TO RELATED APPLICATIONS

This application claims the benefit under 35 U.S. C. § 119(e) of U.S. Provisional Patent Application No. 63/688,244, filed 2024 Aug. 28, entitled “System and Method for Autonomous Task Automation and Orchestration Without Traditional Integration in Software Applications.” A claim for the benefit of the prior-filed provisional application is presented in the Application Data Sheet (ADS) pursuant to 37 C.F.R. § 1.76. The entire disclosure of the provisional application is incorporated by reference to the extent permitted.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX SUBMITTED ON READ-ONLY OPTICAL DISC

Not Applicable.

### BACKGROUND OF THE INVENTION

Field of Endeavor. The disclosure relates to computer-implemented task automation and software orchestration across heterogeneous applications (desktop, web, mobile, terminal, and virtual desktop environments).

Description of Related Art. Conventional automation solutions typically rely on: (i) documented application programming interfaces (APIs) and software development kits (SDKs), (ii) prebuilt connectors and integrations, (iii) DOM/selector bindings or accessibility trees, or (iv) coordinate-based macros. These approaches require per-application engineering, are fragile under user-interface (UI) changes, and are impractical for legacy applications or environments with limited integration options.

Vision-assisted robotic process automation (RPA) improved robustness by detecting onscreen elements, yet such systems generally do not align audio instructions (e.g., call-center speech) or textual procedures/policies with visual context. Process discovery tools that record screens and infer workflows typically separate discovery from execution and still depend on connectors or recorded scripts.

There is a need for a unified system that (a) learns task-level actions and (b) orchestrates multistep processes across different applications using crossmodal information (visual, input events, audio, and text), and that (c) executes by issuing operating-system (OS) input to the UI without invoking the target application's published API at runtime.

### BRIEF SUMMARY OF THE INVENTION

The disclosed systems, methods, and non-transitory media capture and time-align (i) images of displays rendering application UI, (ii) input events, (iii) audio of task requests or instructions, and (iv) text from digital procedures and policies to form crossmodal tokens.

A Large Action Model (LAM) maps crossmodal tokens to UI-level actions. A Large Orchestration Model (LOM) composes and orders such actions to satisfy a goal, while enforcing policy constraints and enabling recovery if verification fails.

At runtime, an executor issues OS-native input signals (keyboard, pointer, touch) to the target UI without invoking any published API of the target application, verifies results visually (e.g., OCR/layout cues), and refines models via a feedback loop. The approach delivers no-integration automation that is robust to UI drift through semantic UI tokenization and function-class reanchoring.

### BRIEF DESCRIPTION OF THE DRAWINGS

FIG. 1 is a system-level block diagram of the Read Everything architecture showing the Input Layer, Alignment & Tokenization, Large Action Model (LAM), Large Orchestration Model (LOM), Executor that issues OS-native input to a target application UI, on-screen verification, feedback learning, policy/role gating, privacy masking, knowledge/policy store, and representative execution environments (browser, legacy desktop, terminal, VDI).

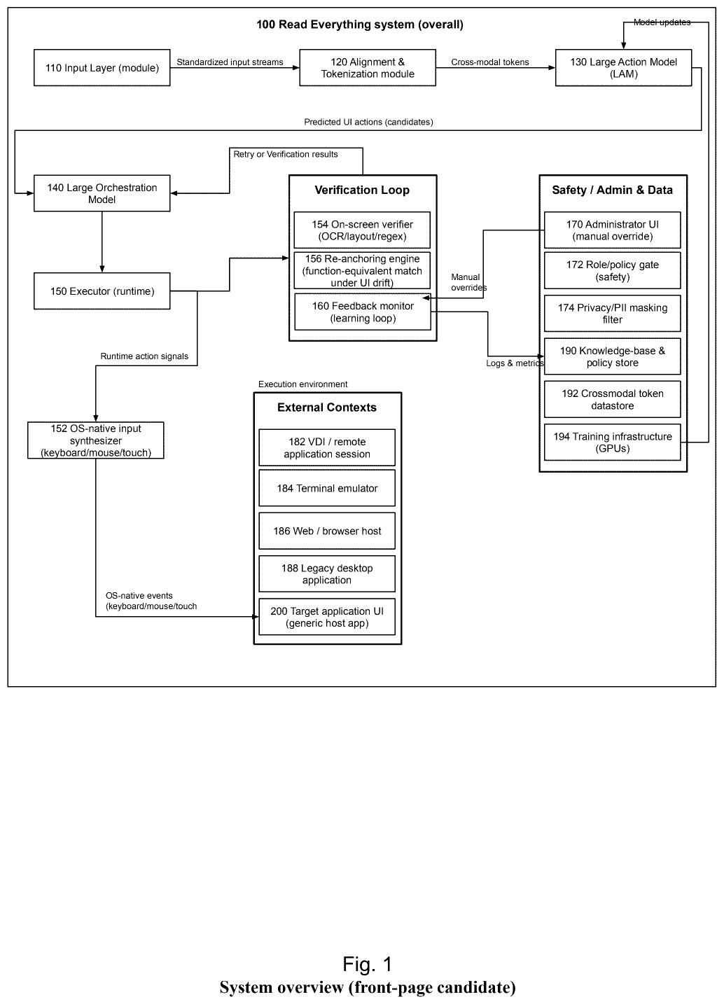

FIG. 2 is a pipeline diagram of alignment and tokenization, illustrating capture of display frames, input events, audio with ASR, and textual procedures/policies, followed by temporal (forced) alignment and OCR/layout analysis to produce cross-modal tokens.

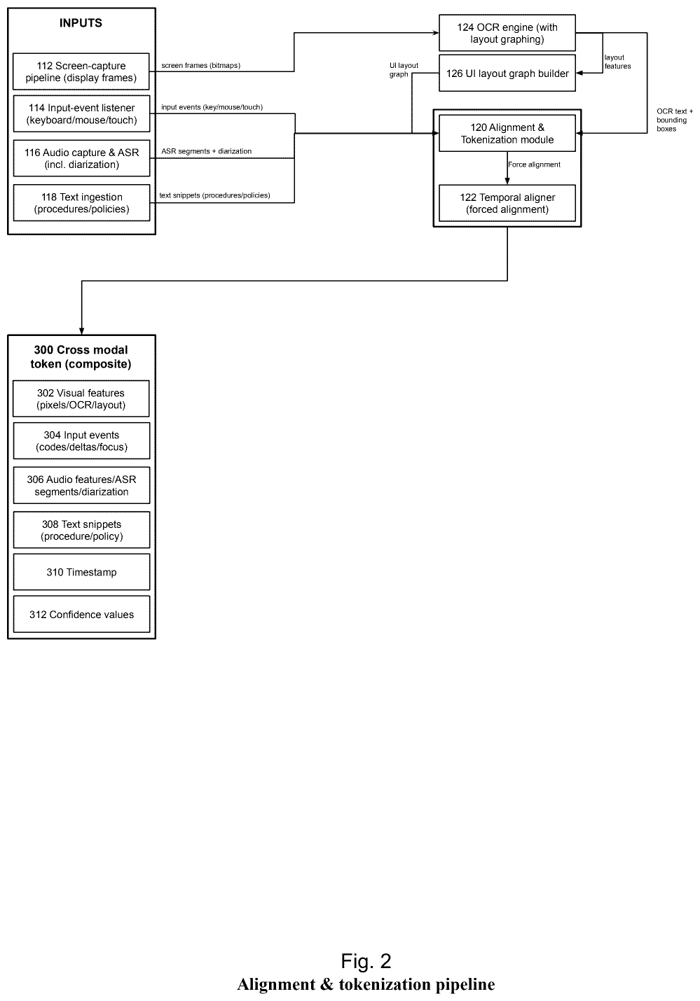

FIG. 3 is a data-structure view of a cross-modal token, showing fields for visual features (pixels/OCR/layout), input events, audio/diarization segments, textual snippets, timestamps, and confidences.

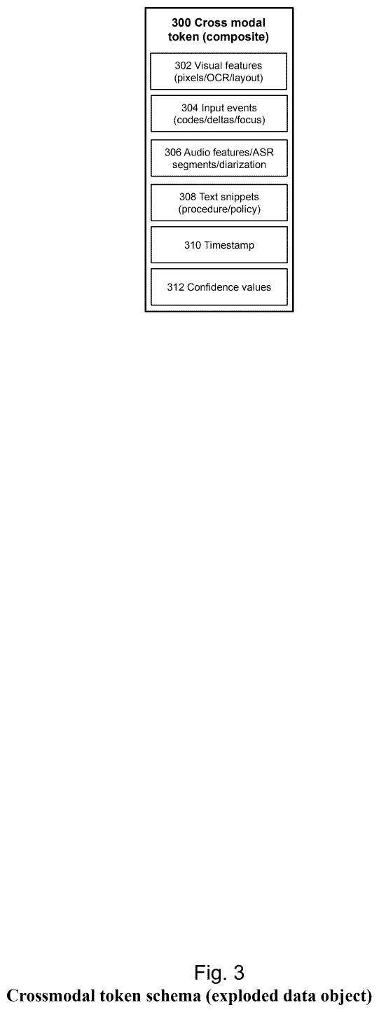

FIG. 4 is a functional diagram of the Large Action Model (LAM), receiving cross-modal tokens and semantic UI tokenization to predict UI-level actions, with a re-anchoring mechanism that locates function-equivalent elements under UI drift.

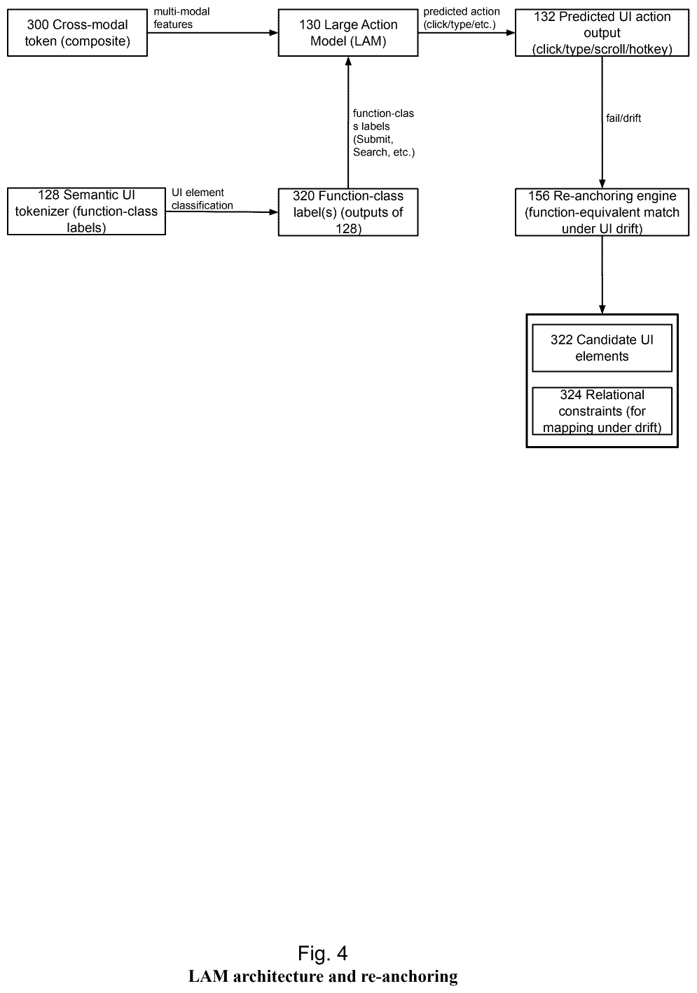

FIG. 5 depicts the Large Orchestration Model (LOM) as a latent process graph with nodes (tasks) and edges (ordering, branching, retries), including a policy-constraint evaluator that conditions plans on enterprise procedures/policies.

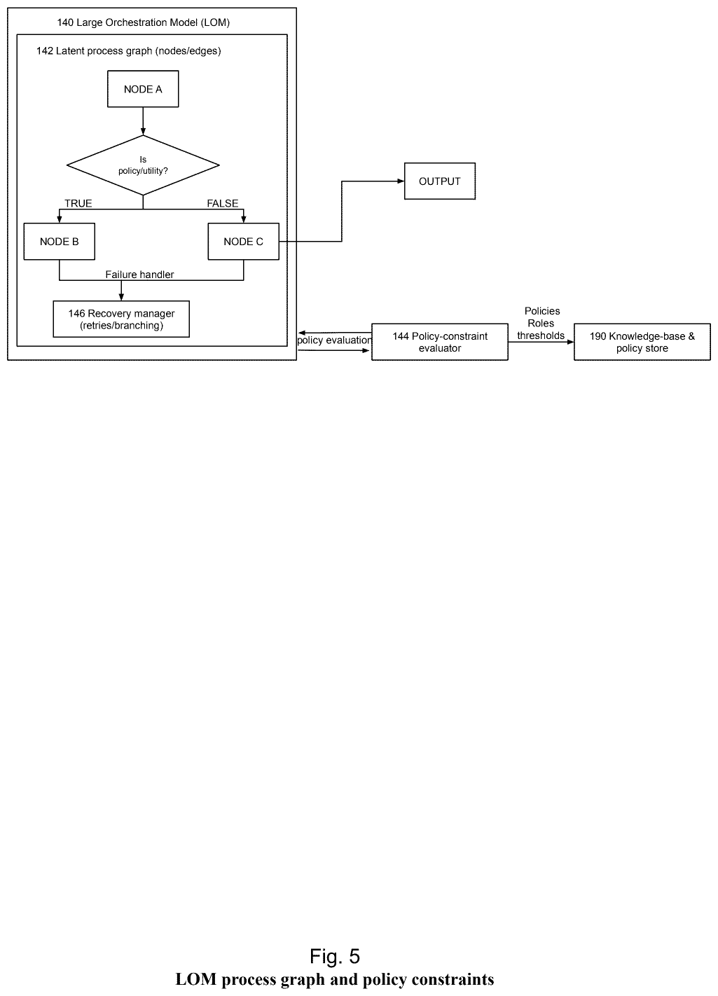

FIG. 6 illustrates the runtime execution and verification loop, in which the LOM orders actions, the Executor synthesizes OS-native keyboard/mouse/touch events to the target UI, results are verified on-screen using OCR/layout (e.g., confirmation code/regex), and failures trigger recovery or re-anchoring.

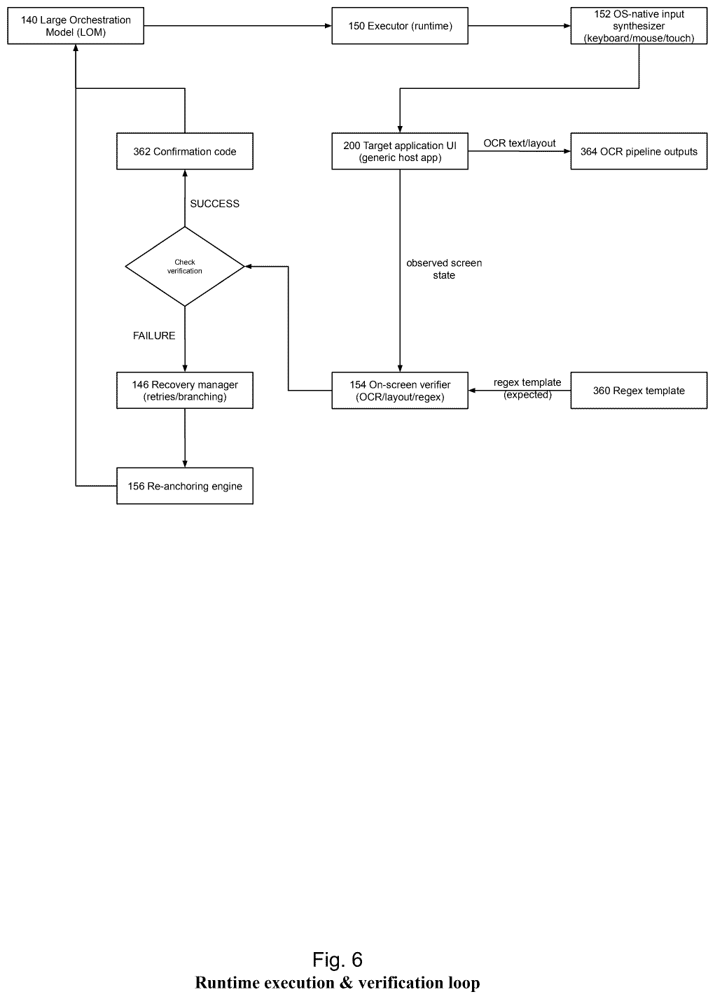

FIG. 7 provides comparative UI scenes (before/after change) annotated with semantic function-class labels, showing how the system re-anchors to a function-equivalent control when a dialog is rearranged.

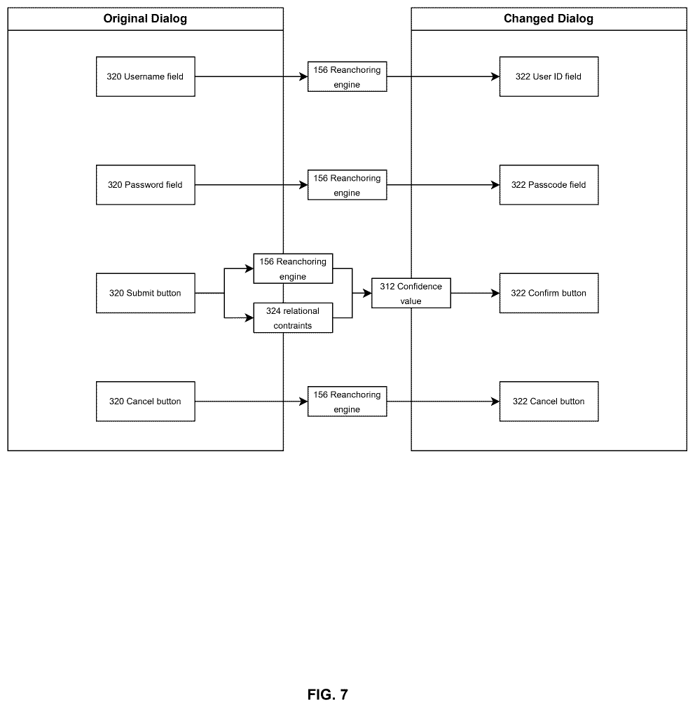

FIG. 8 is an audio/intent view showing goal extraction from call audio with speaker diarization and ASR segments feeding the LOM for plan composition.

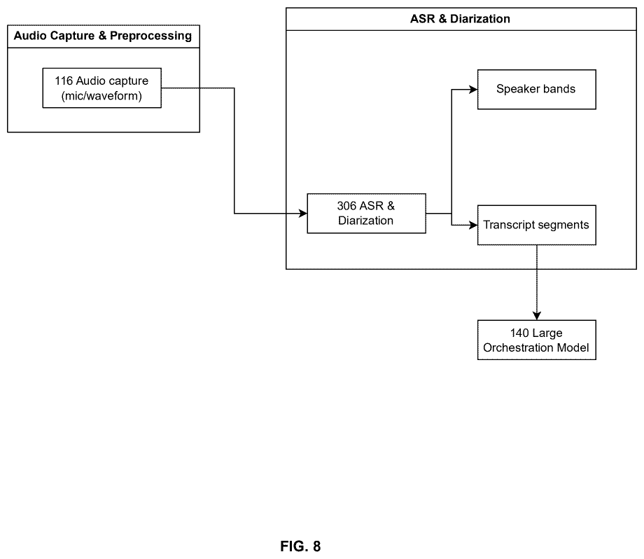

FIG. 9 details policy-driven verification, including OCR extraction of identifiers or confirmation codes and comparison against stored templates or regular expressions, with results forwarded to the feedback loop.

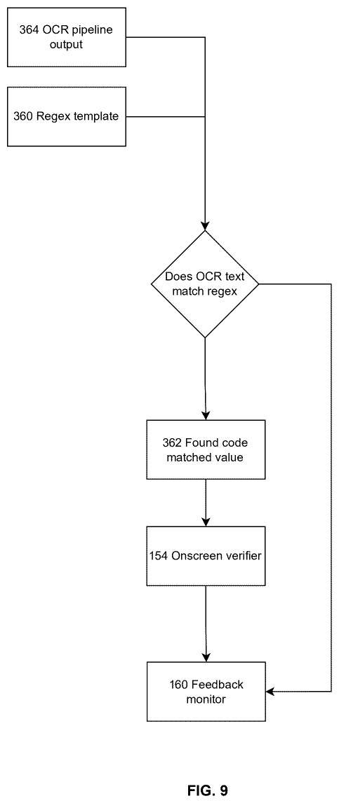

FIG. 10 is a scheduler diagram for batch execution and rate limiting, depicting queued goals dispatched to the LOM/Executor with throttles to comply with IT/policy constraints.

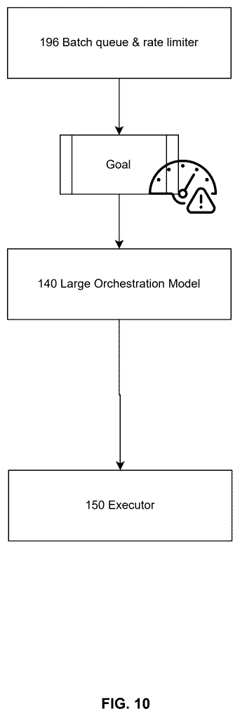

FIG. 11 shows representative deployment contexts—a browser, a legacy desktop application, a terminal emulator, and a virtual desktop session—each controlled by OS-native input without invoking the target application's published API.

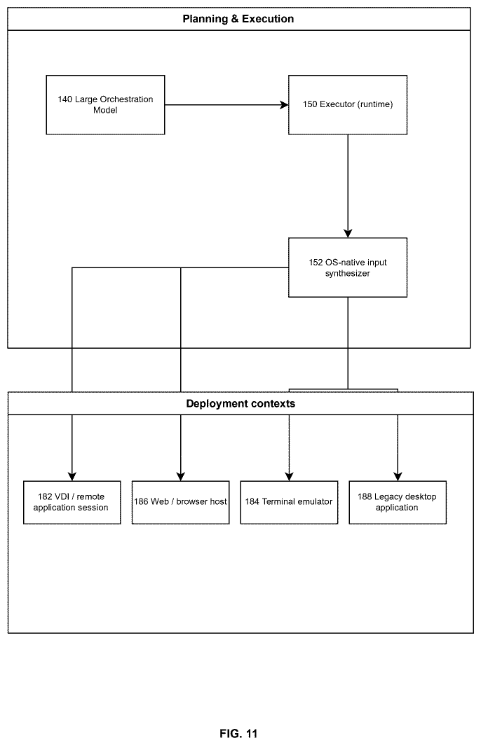

FIG. 12 is an interface view of the administrator console, including role/policy gating, privacy/PII masking, logs/audit, and a manual-override path that feeds the learning loop.

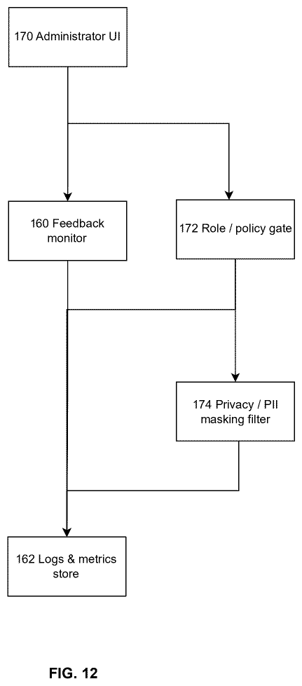

FIG. 13 is a training pipeline diagram showing storage of cross-modal tokens/logs, GPU-backed training, behavior-cloning supervision from user actions and procedure labels, and resulting LAM/LOM model artifacts.

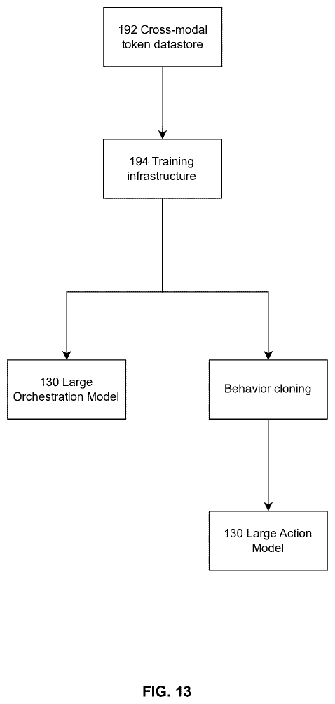

### DETAILED DESCRIPTION OF THE INVENTION

### Definitions

“Published API of a target application” means a documented programmatic interface or plugin interface (e.g., REST, GraphQL, COM, SDK) intended for third-party integration with that application. Generating OS-native input signals (e.g., keyboard, mouse, touch) and interacting with the UI surface does not constitute invoking a “published API of the target application.”

“Crossmodal token” is a structured, time-synchronized tuple comprising: visual features (pixels, OCR text, UI layout graph), input events (key codes, pointer deltas, focus changes), audio-derived features (ASR transcript segments, speaker diarization tags, intent markers), and textual context (procedure/policy snippets), with timestamps and confidence values.

“Semantic UI tokenization” denotes detection and labeling of UI elements by function class (e.g., submit, search field, record-ID link) using combined computer vision, OCR, and layout embeddings; accessibility metadata may be used opportunistically.

“Reanchoring” is the process of locating a function-equivalent UI element when an expected element is absent or repositioned, based on semantics and relational constraints rather than fixed coordinates.

### System Overview

The system comprises: (i) an Input Layer; (ii) an Alignment & Tokenization module; (iii) a Large Action Model (LAM); (iv) a Large Orchestration Model (LOM); (v) an Executor that issues OS-native input; (vi) a Feedback Monitor; and (vii) an Administrator UI. The system may operate on on-premises servers or cloud instances and interface with Windows®, macOS®, Linux®, browsers, virtual desktop infrastructure (VDI), mobile mirroring, and terminal emulators.

### Input Layer; Alignment & Tokenization

The Input Layer captures display frames (e.g., 5-30 fps), input events, audio of requests or instructions, and textual materials such as procedures, knowledge-base articles, and compliance policies.

An aligner performs temporal alignment to associate ASR transcript segments and text snippets with visual transitions (e.g., window/dialog changes inferred visually) and user input events. The result is a sequence of crossmodal tokens suitable for training and inference.

### Large Action Model (LAM)

The LAM maps a current crossmodal context to a UI-level action (e.g., click(x, y), type(text), hotkey(seq), drag(rect), scroll(delta), focus(window)). Supervision includes observed user input events aligned to frames, textual step labels derived from procedures, and audio-derived intent markers. During inference, the LAM uses semantic UI tokenization to prefer function-class matches and supports reanchoring under UI drift. The LAM may be realized as a transformer policy with cross-attention over visual and text/audio embeddings and over UI layout graphs.

### Large Orchestration Model (LOM)

The LOM is a planner that composes LAM task primitives into a goal-satisfying sequence. The LOM maintains a latent process graph whose nodes represent tasks and whose edges encode ordering, branching, retries, and recovery conditioned on visual confidence and policy constraints. The goal may be extracted from audio and refined by textual procedures. The LOM selects among candidate sequences using a confidence-weighted utility that includes a policy-violation cost.

### Execution Without Published APIs; Verification

The Executor issues OS-native input signals directed to the target UI, refraining from calling any published API of the target application. Verification uses subsequent display frames to detect success states via OCR and layout cues (e.g., confirmation codes, success banners). If verification fails, the LOM engages recovery (e.g., backtracking to a prior state, alternative branch, or reanchoring to a function-equivalent element).

### Feedback, Safety, and Privacy

A feedback loop logs outcomes, anomalies, and manual overrides supplied via the Administrator UI; these data update the LAM and LOM. Privacy filters mask or redact personally identifiable information (PII) in captured frames and logs. A role-policy gate prevents actions outside permitted scopes and provides audit logging (e.g., action bundles and associated screen-evidence hashes, if enabled).

### Computing Environments and Deployment

Deployments may be single-tenant or multi-tenant. Training and inference may use GPUs. The system supports batch execution with per-application throttles and rate limiting to conform with IT policies. Execution may occur within VDI sessions or remote application windows. Terminal emulators are handled via visual tokens and OS-native typing.

### Best Mode

At filing, the best mode includes: (i) screen capture at 10-15 fps with OCR and layout graph extraction; (ii) a temporal aligner performing forced alignment between ASR transcript segments and visually detected UI state transitions; (iii) a transformer-based LAM trained by behavior cloning from user logs enriched with policy step labels; (iv) a graph-policy LOM trained by imitation plus self-play on synthetic UI states to learn recovery; (v) an Executor issuing OS input via approved system calls; (vi) OCR-based verification using regular-expression templates defined in digital procedures; and (vii) an Administrator dashboard with audit, role policies, batch controls, and manual override.

### Exemplary Use Scenarios

Customer-support wrap-up: a wrap-up goal extracted from call audio triggers multi-application updates (CRM, billing, knowledge base). The system issues OS input, performs onscreen verification, and logs evidence—without calling the CRM or billing APIs.

Legacy data migration: a green-screen terminal UI is used to transfer records into a modern web application while conforming to a textual validation policy; verification is OCR-based.

Insurance first-notice-of-loss (FNOL): from transcript-derived intent, the LOM orchestrates policy lookup, claim creation, and document upload across applications, verifies claim identifiers by OCR, and queues batch actions with rate limits.

### Distinctions Over Prior Approaches

The disclosed system jointly (a) aligns visual, input, audio, and textual streams into crossmodal tokens; (b) trains a task-level LAM and a process-level LOM that composes tasks across applications under policy constraints; and (c) executes via OS-native input while refraining from invoking a published API of the target application at runtime. This combination provides technical improvements in generalization, robustness to UI drift (via semantic tokenization and reanchoring), and deployability in legacy environments without custom integrations.

1. A computer-implemented method for automating tasks in a target software application without invoking a published application programming interface (API) of the target application at runtime, the method comprising:
(a) capturing, from a user device executing the target application, synchronized streams including (i) images of a display on which the target application renders a user interface, (ii) input events received at the user device, (iii) audio of a task request or instruction, and (iv) text of at least one digital procedure or policy;
(b) generating, by an aligner executed by one or more processors, time-aligned crossmodal tokens that associate visual features and layout, the input events, segments of an automatic speech recognition transcript of the audio, and text snippets from the at least one digital procedure or policy;
(c) training a Large Action Model (LAM) to predict a user-interface action for the target application from the crossmodal tokens;
(d) training a Large Orchestration Model (LOM) to select and order multiple actions output by the LAM to satisfy a goal expressed in the audio or the text;
(e) executing the ordered actions by generating operating-system native input signals directed to the user interface of the target application without invoking a published API of the target application; and
(f) verifying completion by analyzing subsequent images of the display and, based on a result, updating at least one of the LAM or the LOM.

2. The method of claim 1, wherein generating time-aligned crossmodal tokens includes forced temporal alignment of speech transcript segments to user-interface state transitions detected in the images of the display.

3. The method of claim 1, wherein the LAM uses semantic user-interface tokenization that labels user-interface elements by function class obtained from combined computer-vision, optical character recognition, and layout graph features.

4. The method of claim 1, wherein the LOM maintains a latent process graph whose nodes reference LAM task primitives and whose edges encode ordering, branching, retries, and recovery policies responsive to visual confidence.

5. The method of claim 1, further comprising reanchoring a target user-interface element by matching a function-equivalent element when an expected element is absent or moved.

6. The method of claim 1, wherein the at least one digital procedure includes a compliance policy, and the LOM constrains an action sequence to satisfy the compliance policy.

7. The method of claim 1, wherein the audio comprises a customer call recording, and the goal is extracted from the call.

8. The method of claim 1, further comprising masking personally identifiable information in captured images before storage.

9. The method of claim 1, wherein verifying completion includes optical character recognition of a confirmation code and comparison to a regular expression specified in the digital procedure.

10. The method of claim 1, wherein the LAM is trained using behavior cloning from observed user actions together with textual step labels derived from the digital procedure.

11. The method of claim 1, wherein executing the ordered actions includes issuing keyboard, mouse, or touch events via operating-system calls while refraining from invoking a published API of the target application.

12. The method of claim 1, wherein the target application is a legacy application lacking accessibility metadata and the method completes the task using only the images of the display and the operating-system native input signals.

13. The method of claim 1, wherein the LOM selects among alternative action sequences using a confidence-weighted utility that incorporates a policy-violation cost.

14. The method of claim 1, wherein the crossmodal tokens further include a speaker diarization tag distinguishing customer from agent speech.

15. The method of claim 1, wherein the LAM and the LOM are updated by a feedback loop that incorporates manual overrides from an administrator dashboard.

16. The method of claim 1, wherein the capturing and executing occur within a virtual desktop session or a remote application window.

17. The method of claim 1, further comprising batch execution of multiple goals by queuing LOM plans and rate-limiting operating-system native input signals.

18. The method of claim 1, wherein the text of the digital procedure includes an enterprise knowledge base and change logs, and the LOM adapts the latent process graph when the knowledge base changes.

19. A system comprising one or more processors and memory storing instructions that, when executed by the one or more processors, cause the system to perform the method of any one of claims 1-18.

20. A non-transitory computer-readable medium storing instructions that, when executed by one or more processors, cause performance of the method of any one of claims 1-18.
